(19) United States
(12) Patent Application Publication
(10) Pub. No.: US 2002/0046203 A1
(43) Pub. Date: Apr. 18, 2002

(54) Method and apparatus for providing ratings of web sites over the internet

(75) Inventors: Brian Siegel, Washingtonville, NY (US); Philip Michael Abram, Warwick, NY (US); Marc Beckwitt, San Clemente, CA (US); Gregory D. Gudorf, San Diego, CA (US); Kazuaki Iso, Oradell, NJ (US); Brian Raymond, San Diego, CA (US); Christopher M. Tobin, Central Valley, NY (US)

Correspondence Address: MAYER, FORTKORT & WILLIAMS, PC, 251 NORTH AVENUE WEST, 2ND FLOOR, WESTFIELD, NJ, 07090, US

(73) Assignee: The Sony Corporation/Sony Electronics Inc.

(21) Appl. No.: 09/888,231

(22) Filed: Jun. 22, 2001

Related U.S. Application Data
(60) Provisional application No. 60/213,112, filed on Jun. 22, 2000.

(51) Int. Cl. G06F 7/00

(52) U.S. Cl. 707/1; 707/3

(57) ABSTRACT

A method is disclosed for providing an evaluation of a plurality of information sites to a user over a packet-switched network when the user submits a search request through a user interface device in communication with the packet-switched network. The method begins by acquiring a search result, responsive to the search request, which includes network addresses for the plurality of information sites. Next, a plurality of individuals are selected who were previously in communication with at least one of the information sites over the packet-switched network and who meet at least one predefined criterion selected by the user. A plurality of evaluations of at least one of the information sites is retrieved from a database, which are provided by the plurality of individuals. Finally, a rating based on the evaluations is forwarded to the user over the packet-switched network.

### STATEMENT OF RELATED APPLICATION

This application is related to co-pending U.S. Provisional application No. 60/213,112, filed Jun. 22, 2000, entitled “Dynamic Presentation of Internet Search Results”. This application is incorporated herein by reference in its entirety.

### FIELD OF THE INVENTION

The present invention relates generally to a method and apparatus for providing ratings of web sites over the Internet, and more particularly to a method and apparatus for providing ratings of web sites over the Internet when a user is conducting an Internet search.

### BACKGROUND OF THE INVENTION

The Internet is accessed worldwide by millions of users every day for a wide range of personal, professional and entertainment purposes. Internet access provides a user with connections to computers and associated databases around the world, thereby promoting a rapid exchange of messages and other information. Internet accessibility is particularly advantageous because it allows information to be delivered to users through the use of low-cost connections to other computers through local phone lines, which access heretofore would have been only possible through long-distance telephone connections or through physical transfer of data through, for example, “hard copy” printed material, computer diskettes, or the like.

One of the primary advantages of the Internet is that information can be rapidly disseminated worldwide. Moreover, information can also be immediately accessed on virtually any subject. Some examples, among many others, of items and information that may be found include stock and other financial information, newspapers, book reviews, medical research, automobile shopping, movie theater schedules, movie clips, sound clips, and entertainment reviews.

Unfortunately, research on the Internet can be tedious and time consuming. This is because searches on the Internet are typically conducted through a variety of “search engines,” which are indiscriminate regarding the “search hits” or citations they provide. For example, tens of thousands of citations may be the result of a search. Further, duplicate search results may also be retrieved because of the particular search engine techniques employed.

It would be helpful to Internet users if a service were available to interactively guide the user to the most pertinent and useful websites from among those that have been located during a search as well as to rank individual web pages as they are retrieved.

### SUMMARY OF THE INVENTION

In accordance with the present invention, a method is disclosed for providing an evaluation of a plurality of information sites to a user over a packet-switched network when the user submits a search request through a user interface device in communication with the packet-switched network. The method begins by acquiring a search result, responsive to the search request, which includes network addresses for the plurality of information sites. Next, a plurality of individuals are selected who were previously in communication with at least one of the information sites over the packet-switched network and who meet at least one predefined criterion selected by the user. A plurality of evaluations of at least one of the information sites is retrieved from a database, which is provided by the plurality of individuals. Finally, a rating based on the evaluations is forwarded to the user over the packet-switched network.

In accordance with one aspect of the invention, an advertisement is forwarded to the user over the packet-switched network. In some cases the advertisement may be selected based at least in part on the search request. Alternatively, the advertisement may be selected based in part on user information located in the database, or based on both the search request and user information.

### BRIEF DESCRIPTION OF THE DRAWINGS

FIG. 1 shows the overall system architecture for practicing the present invention.

FIG. 2 shows an illustrative user interface device that may be employed in connection with the present invention.

FIG. 3 shows a block diagram of a computer server that may be employed in practicing the present invention.

FIG. 4 shows an illustrative set of search results that may be displayed as a web page on a display of the user interface device along with a pop-up window in accordance with the present invention.

FIG. 5 shows an illustrative web site on the user interface display, which is selected from among the search results along with a pop-up window that allows users to rate the web site.

FIG. 6 is a flowchart depicting how a user registers with the rating service.

### DETAILED DESCRIPTION

At this point it is worth noting that any reference herein to “one embodiment” or “an embodiment” means that a particular feature, structure, or characteristic described in connection with the embodiment is included in at least one embodiment of the invention. The appearances of the phrase “in one embodiment” in various places herein are not necessarily all referring to the same embodiment.

The present invention provides a method and apparatus allowing individuals to be presented with Internet search results identifying web sites in accordance with feedback from other Internet users who have rated the web sites. The service maintains a database that relates URL's of various web sites with a ranking that has been assigned to those URL's by the participants in the ranking process. Moreover, the user may have the search results ranked by a subset of the participants, which subset the user selects based on the expertise and interests of the participants. For example, a user might be interested in locating the best, most informative web sites describing ski resorts in the Northeast United States. In this case the user may specify that the subset of the participants ranking the web sites be limited to those who are advanced or expert skiers and who reside in the Northeast United States, since presumably they will have the greater familiarity with web sites discussing local resorts than individuals residing elsewhere.

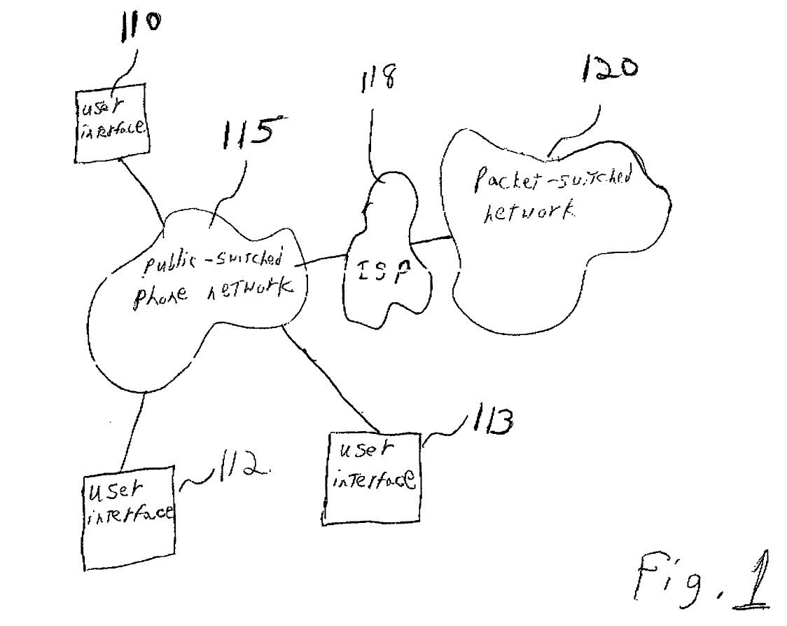

The system architecture of one embodiment of the apparatus and method of the present invention is illustrated with reference to FIG. 1. The apparatus of the present invention comprises user interface devices 110-113, Internet Service Provider (ISP) 118, and packet-switched network 120. User interface devices 110-113 and ISP 118 are connected, using, for example, a public switched phone network 115, such as those provided by a local or regional telephone operating company. Connection may also be provided by dedicated data lines, cellular, cable, Personal Communication Systems (“PCS”), microwave, or satellite networks. Packet-switched network 120 is a collection of individual networks that are linked together by a set of standard protocols. One example of a packet-switched network is the Internet, which employs standard protocols such as TCP/IP and HTTP. For purposes of illustration only and not as a limitation on the invention, packet-switched network 120 will often be referred to as the Internet in what follows.

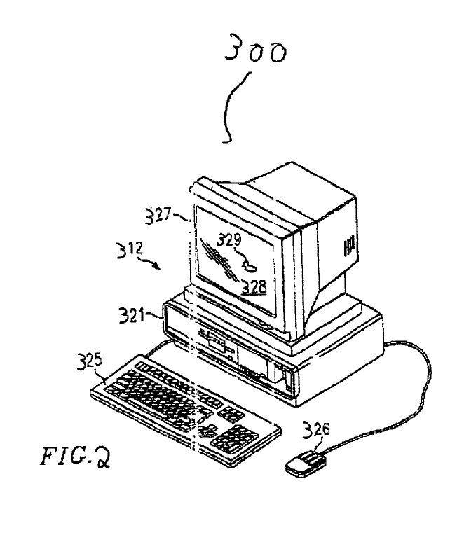

FIG. 2 shows a block diagram of an illustrative user interface device 300 that may be employed in connection with the present invention. While the device 300 is illustrated as a general purpose computer, those or ordinary skill in the art will recognize that the user interface device may be any device that can communicate with, and download information from, a packet-switched network such as the Internet. For example, the user interface device may be a web-enabled television, telephone or other online appliance. As shown, the device 300 includes a system unit 321, a keyboard 325, a mouse 326 and a display unit 327. The screen 328 of the display unit 327 is used to present a graphical user interface (GUI). The graphical user interface supported by the operating system of the device 300 allows the user to use a point and shoot method of input, i.e., by moving the mouse pointer 329 to an icon representing a data object at a particular location on the screen 328 and pressing on the mouse buttons to perform a user command or selection. This type of arrangement also allows the user to directly manipulate an icon from one position to another on the screen, all in a known manner.

ISP 118, when contacted by one of the user interface devices 110-113, negotiates a connection with the user interface device using known protocols such as the Point-to-Point (PPP) protocol connection. Once connected, interface devices 110-113 use the TCP/IP protocol suite to communicate with other devices over the Internet, such as device 140 depicted in FIG. 1.

Device 140 may provide over packet-switched network 120 user-viewable hypertext documents (commonly referred to as a web document or web page), which are interlinked with one another. Accordingly, device 140 may be referred to as a web site. Currently, the primary protocol for allowing applications to locate and acquire web documents is HTTP, and the web pages are encoded using HTML. However, as used herein, the terms “web” and “web site” are intended to encompass markup languages and transport protocols, which may be used in place of, or in addition to, HTML and HTTP, such as XML, for example. User interface devices 110-113 contact web site 140 using the web site's Internet address, which is referred to as its URL (Universal Resource Locator).

A user will commonly perform the following exemplary steps when conducting an Internet search to locate web sites of interest.

The user contacts, via public-switched phone network 115, ISP 118 through a telephone modem-dialing program so that the user's interface device establishes a communication link with the ISP;

A “browser” application program, e.g., Netscape™., is executed on the user's interface device;

A connection to an Internet “search engine” website, e.g., Yahoo™, Web Crawle™, Infoseek™, and the like, is executed by the user through the browser, thereby establishing a connection between the user's interface device and the search engine website;

Once the search engine website connection is made, a search engine input screen is then displayed on the monitor of the user's interface while the search engine is idle in an “input wait mode”;

A search strategy in the form of key word search terms is provided by the user as textual input to the search engine on the search engine input screen through the keyboard of the user interface device;

In turn, the search engine awaits a “finished” input command from the user in the form of a mouse click of an icon control button or alternatively a stroke of the “enter” key on the keyboard;

The user's search strategy request is then delivered over the packet-switched network to the search engine;

A list of Internet websites (search hits or citations) and corresponding URLs (Universal Resource Locators) or website addresses are received and displayed on the user's display; and

The user may then select a particular URL of interest by a “mouse click” which causes information associated with the URL to be subsequently retrieved and displayed.

Alternatively to the foregoing scenario, if the URL or “website address” is known, the above steps (3) through (9) may be replaced by entering the website address into a URL input line of the browser for subsequent “direct” connection to the website and subsequent retrieving of the information associated therewith. Furthermore, steps 1 and 2 may also be reversed, i.e., the browser application, once executed, may then call up the dialing program.

As previously mentioned, a search conducted in the above-described manner could retrieve thousands or even tens of thousands of citations, leaving the user with essentially no guidance in determining the value of those citations. To alleviate this problem, the present invention provides a rating service which dynamically rates individual web sites as they are retrieved and ranks a set of web sites that have been located during a keyword search. The rating service employs a database that maintains a list of registrants who rate the various web sites they visit. In one embodiment of the invention the database is maintained by ISP 118. In this case the rating service is offered as an adjunct service to the ISP's subscribers. Of course, the rating service may be offered by other entities. For example, referring again to FIG. 1, the rating service may be offered by a third party that maintains a device such as device 140, which, as mentioned, may operate as a web server so that it can transmit and receive hypertext documents. In this case individuals who wish to use the rating service must be subscribers to the third party. In some cases the third party may be a search engine provider so that the searching functionality and the rating functionality are available from the same web site. Regardless of the entity offering the rating service, the entity will maintain a ratings database for storing the data.

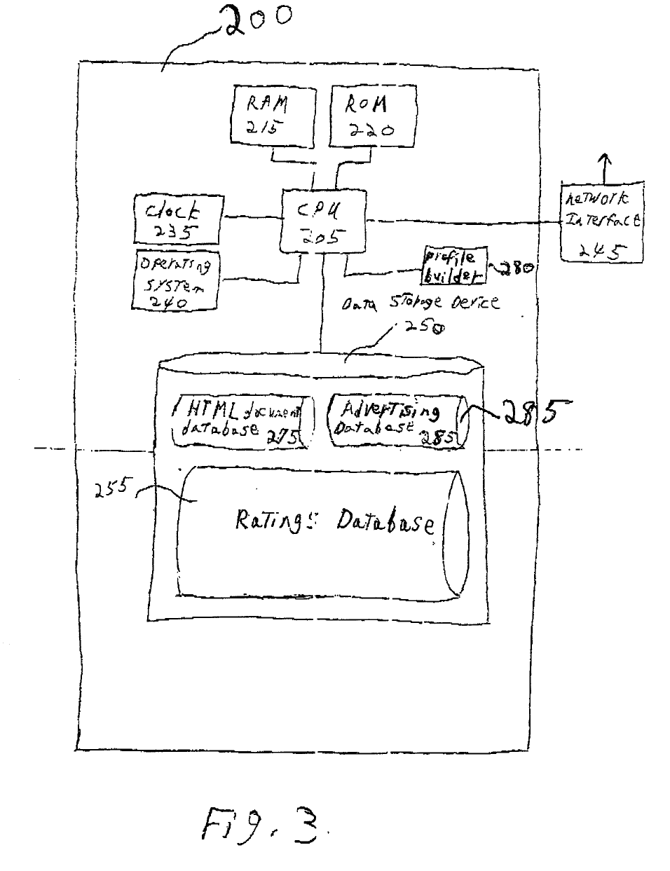

The ratings database will typically be incorporated in a computer server such as server 200 shown in FIG. 3. System 200 includes central processor (CPU) 205, RAM 215, ROM 220, clock 235, operating system 240, network interface 245, and data storage device 250. Server 200 may be a conventional personal computer or computer workstation with sufficient memory and processing capability. Server 200 must be capable of high volume transaction processing, performing a significant number of mathematical calculations in processing communications and database searches. Illustrative processors that may be employed include a Pentium microprocessor, commonly manufactured by Intel Inc., a PowerPC available from Motorola, or an UltraSPARC processor available from Sun Microsystems.

Data storage device 250 may include hard disk magnetic or optical storage units, as well as CD-ROM drives or flash memory. Data storage device 250 contains databases used in the processing of transactions in the present invention, including ratings database 255, which, as previously discussed, maintains a list of URL's, registrants, and ratings of the URL's by the registrants. Depending on the functionality to be provided, data storage device 250 may also include HTML document database 275 and advertising database 285. In one embodiment of the invention database software, such as available from Oracle Corporation, is used to create and manage these databases.

Ratings database 255 includes a list of all URLs visited by the registrants to the rating service and, for each URL, a series of ratings which have been assigned by each of the registrants who have visited a given URL. The ratings may be quantitative, e.g., a numerical or alphabetical rating, and/or qualitative, e.g., a brief verbal description. The ratings database 255 also includes pertinent demographic and biographical data concerning the registrants so that other registrants can access the registrant's qualifications to rate a given web site. For example, the demographic data may include the age and residence of the registrants and the biographical data may include a list of subject areas in which the registrants claim a degree of knowledge as well as their level of expertise in those areas. In one particular embodiment of the invention, the rating database 255 includes participant data which has been provided by selecting from pre-defined categories such as activities, hobbies, demographics, school subjects studied, and professional affiliations. In this embodiment the participants rank their interest and expertise for various items in each predefined category.

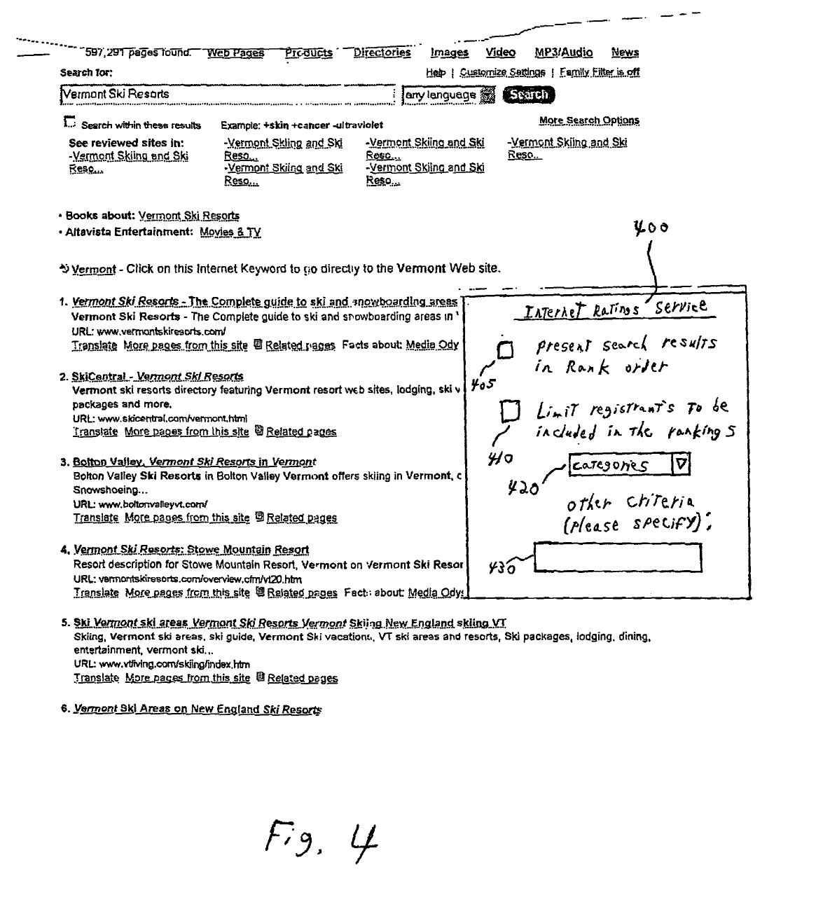

Once an individual has registered with the rating service (a process which is described below), its operation is as follows. It should be noted that for purposes of illustration only the user interface device employed in this and subsequent examples will be a personal computer. However, as previously mentioned, other interface devices that provide connectivity to the Internet or other packet-switched network may also be employed. Assuming a user-participant wants to conduct an Internet search such as previously described in steps (1)-(9), the user-participant begins the process by performing steps (1)-(6) as described above. After step (6) has been completed, that is, just after entering the search request, a pop-up window appears on the display of the user-participant's personal computer. In some embodiments of the invention the pop-up window will be visible on the user display whenever the user-participant is conducting an Internet session. The pop-up window includes a number of selections from among which the user-participant may choose. In the exemplary pop-up window 400 shown in FIG. 4, for instance, the user has the option of having the search results presented in rank order based on their individual ratings by the other registrants by checking box 405. In addition, the user-participant may specify any criteria that should be used to select those registrants to be used in determining the ranking by checking box 410 and typing the criteria in text box 430. Alternatively, or in addition thereto, the user may be offered the option of selecting criteria from a pull-down menu 420. For instance, the user-participant may be interested in receiving ratings from participants who consider themselves experts in a given subject and who reside in a given geographical region such as the same city, state, or country as the user-participant. If no criteria is specified, all the registrants who have rated a given web site will be used to determine its ranking. The specified criteria is used by CPU 205 (see FIG. 3) to select appropriate registrants from ratings database 255 based on their biographical information maintained in the ratings database 255. CPU 205 then arranges the search results received from the search engine so that they appear on the user's display in accordance with their rank as determined by the ratings of the selected participants.

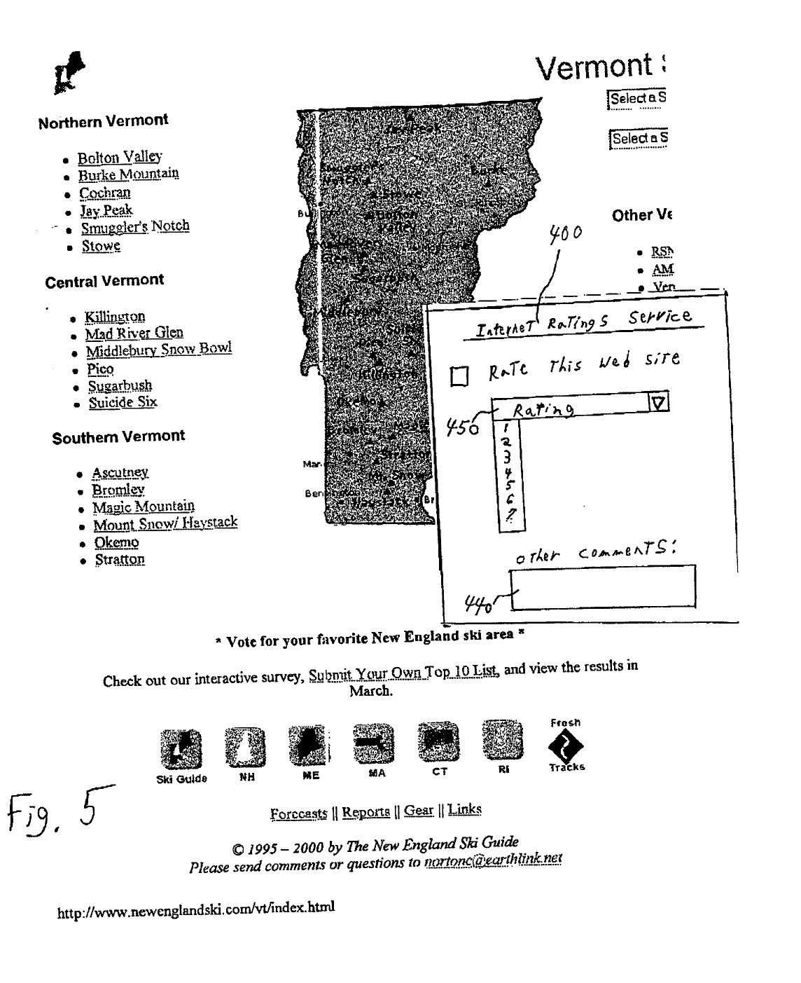

Referring to FIG. 5, after the user-participant has selected a particular URL so that its associated web page appears on the user's display, pop-up window 400 displays a text box 440 (and/or a pull-down menu 450 of predefined ratings) so that the user can rate web sites he or she visits. If the user has previously visited a given web site, the user will be given an opportunity to revise his or her previous ratings. The ratings will be stored in the ratings database 255 so that they will be available for subsequent participants who visit those web sites.

Once the user-participant has made the proper selections in the pop-up window 400, the inventive process continues with the following steps.

After entering the search request, the user-participant's search strategy request is delivered over the packet-switched network to the search engine, instructing the search engine to forward the search results to the server associated with the ratings service (assuming the search engine provider and the ratings service provider are not the same);

A list of Internet websites (search hits or citations) and corresponding URL's or website addresses are received by the rating service;

The rating service server compares the web sites received from the search engine with the web sites stored in its ratings database, and for those found therein, retrieves the ratings data associated therewith;

The rating service server eliminates from the ratings data any ratings from participants who do not meet the criteria specified by the user-participant;

The rating service server calculates an overall ranking of the web sites included in the search results and which it has found in its database. The overall ranking may be calculated in any manner known to those of ordinary skill in the art, including straightforward averaging or the like;

The URLs of the Internet websites are forwarded to the user-participant's display in rank order. Those websites that have not been rated may be so indicated in any appropriate manner; and

The user-participant may select one or more URLs based on the rankings and/or any textual comments that have been provided therewith.

If instead of conducting an Internet search, the user-participant directly enters the URL of a website into the browser so that a direct connection can be established to the website, the URL is forwarded to the rating service server. In turn, the server forwards any available ratings to the user-participant, except of course, for any ratings from participants who do not meet the criteria which have been specified by the user-participant.

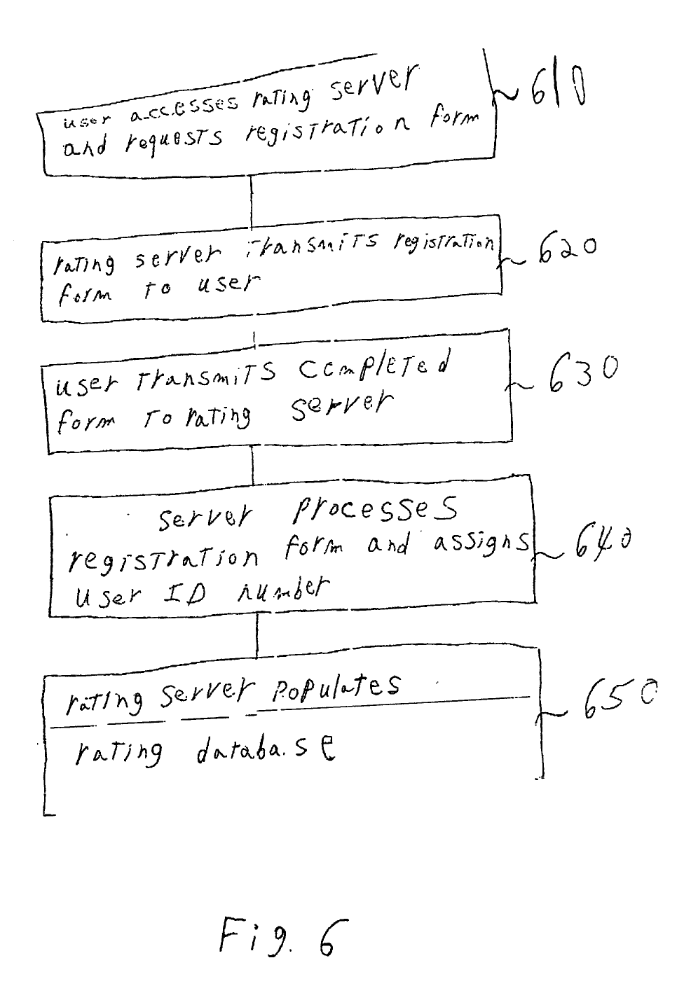

FIG. 6 shows an exemplary process by which a user registers with the rating service. Once again, in this example the user interface device is assumed to be a personal computer. Assuming for purposes of illustration only that server 200 (see FIG. 3) is a web server, the registration process begins at step 610 by selecting the proper hyperlink containing online registration instructions. CPU 205 accesses the HTML document database 275 and, at step 620, returns an online registration application document to the user's web browser. The user can then fill out the detailed online registration form so that necessary demographic and biographic information can be stored in ratings database 255. The user may simply type the information into windows supplied for that purpose. Alternatively, or in addition thereto, the user may be offered the option of selecting items from a pull-down menu.

Once the customer at step 630 completes the electronic registration form, it is sent from the user's personal computer to server 200 for further processing. In response to the submission of the enrollment form, CPU 205 processes the information contained on the registration form at step 640. In one embodiment of the invention, an agent is used to scan the form for ambiguities or pre-specified terms and if such a term is found, to flag the application for further review either electronically or manually. If no such term is found and the application is complete, the central processing unit accepts the registration form.

Once the registration form has been completed the CPU 205 populates rating database 255 at step 550 by creating a database entry corresponding to the user and stores a user ID and the information provided by the user on the registration form as a unique entry. When the user uses the service, URL's visited by the user and their ratings will be stored in the database 255 and associated with the user's unique entry.

In some embodiments of the invention the rating service may further provide advertising to the user-participant. In these embodiments server 200 shown in FIG. 3 may include an advertising database 285 in its data storage device 250, which stores the advertisements. The advertisements may be provided to the user on pop-up window 400. The advertisements that are provided to the user may be advantageously selected in accordance with the information contained in the ratings database 255. Alternatively, or in addition thereto, the advertisements may be selected based on the user-participant's search request. In this way advertisements may be individually selected for a given user-participant based on factors such as the gender, age, location and interests of the user-participant and/or the subject on which the use-participant is currently requesting information. For instance, returning to the aforementioned example of a user interested in locating the best, most informative web sites describing ski resorts in the Northeast United States, the user may receive one or more advertisements pertaining to ski equipment or ski lodges in the Northeast. Additionally, if the user further specifies, for example, that the subset of the participants ranking the web sites be limited to those who are first-time skiers, the advertisements presented to the user may include the names of ski instructors who focus on providing ski lessons to beginners.

1. A method for providing an evaluation of a plurality of information sites to a user over a packet-switched network when the user submits a search request through a user interface device in communication with the packet-switched network, said method comprising the steps of:
acquiring a search result, responsive to the search request, which includes network addresses for the plurality of information sites;
selecting a plurality of individuals who were previously in communication with at least one of the information sites over the packet-switched network and who meet at least one predefined criterion selected by the user;
retrieving from a database a plurality of evaluations of at least one of the information sites, said evaluations being provided by said plurality of individuals; and
forwarding a rating based on said evaluations to the user over the packet-switched network.

2. The method of claim 1 wherein the step of acquiring a search result includes the step of receiving the search result over the packet-switched network.

3. The method of claim 2 wherein the search request is submitted to a search engine and the search result is received from the search engine.

4. The method of claim 1 wherein the step of acquiring a search result includes the step of searching a second database to develop the search result.

5. The method of claim 2 wherein the search request is received from an Internet service provider that forwards the search request from the user.

6. The method of claim 1 wherein said evaluations are quantitative evaluations.

7. The method of claim 1 wherein said evaluations are qualitative evaluations.

8. The method of claim 1 wherein the rating includes a ranking of the plurality of information sites.

9. The method of claim 1 wherein said packet-switched network is the Internet and said network address is an Internet address.

10. The method of claim 9 wherein said Internet address is a URL.

11. The method of claim 1 wherein said information site is an Internet site.

12. The method of claim 1 wherein said Internet site is a web site.

13. The method of claim 1 wherein the user interface device is a personal computer.

14. The method of claim 13 wherein said personal computer includes an Internet browser through which the search request is submitted.

15. The method of claim 1 further comprising the step of providing a window over the packet-switched network to a display of the user interface device, said window including a user selectable icon allowing the user to request that search results be presented in rank order.

16. The method of claim 15 wherein said plurality of individuals providing an evaluation includes a plurality of participants and said window further includes a pull-down menu that includes said series of predefined criteria for selecting a subset of the participants.

17. The method of claim 16 wherein said predefined criteria include self-rated levels of expertise in predefined categories.

18. The method of claim 16 wherein said predefined criteria are selected from the group consisting of activities, hobbies, demographics, subjects studied, and professional affiliations.

19. The method of claim 1 wherein said user and said plurality of individuals are subscribers to a common service.

20. The method of claim 19 wherein said common service is an Internet service provider.

21. The method of claim 19 wherein said common service is offered by a search engine operator.

22. The method of claim 15 wherein said window further includes a text box for receiving user evaluations of the information site.

23. The method of claim 15 wherein said window further includes a pull-down menu that includes a list of predefined ratings reflecting user evaluations of the information site.

24. The method of claim 15 wherein said plurality of individuals providing said evaluations includes a plurality of participants and said window further includes a text box allowing the user to specify at least one criterion for selecting a subset of the participants.

25. The method of claim 15 further comprising the step of forwarding an advertisement to the user over the packet-switched network.

26. The method of claim 15 further comprising the step of forwarding an advertisement to the user over the packet-switched network, wherein said advertisement is provided in said window.

27. The method of claim 25 wherein the step of forwarding an advertisement includes the step of selecting an advertisement based at least in part on the search request.

28. The method of claim 25 wherein the step of forwarding an advertisement includes the step of selecting an advertisement based at least in part on user information located in said database.

29. The method of claim 1 wherein said search request is a key word search request.

30. The method of claim 1 further comprising the step of providing connectivity to the packet-switched network for the user interface device.

31. The method of claim 1 wherein said database includes biographic information concerning said plurality of individuals.

32. The method of claim 31 wherein said biographic information includes self-rated levels of expertise in predefined categories.

33. The method of claim 31 wherein said biographic information includes categories of information selected from the group consisting of activities, hobbies, demographics, subjects studied, and professional affiliations.

34. A method for providing an evaluation of an information site to a user over a packet-switched network when said user enters a network address of the information site into a user interface device in communication with the packet-switched network, said method comprising the steps of:
receiving over the packet-switched network a request from the user to receive an evaluation of the information site;
retrieving from a database a plurality of evaluations of the information site provided by a plurality of individuals who each meet at least one predefined criterion selected by the user and who were previously in communication with the information site over the packet-switched network; and
forwarding a rating based on said evaluations to the user over the packet-switched network.

35. The method of claim 34 wherein said evaluations are quantitative evaluations.

36. The method of claim 34 wherein said evaluations are qualitative evaluations.

37. The method of claim 34 wherein said packet-switched network is the Internet and said network address is an Internet address.

38. The method of claim 37 wherein said Internet address is a URL.

39. The method of claim 34 wherein said information site is an Internet site.

40. The method of claim 39 wherein said Internet site is a web site.

41. The method of claim 34 wherein the user interface device is a personal computer.

42. The method of claim 41 wherein said personal computer includes an Internet browser through which the search request is submitted.

43. The method of claim 34 wherein said plurality of individuals providing an evaluation includes a plurality of participants and further comprising the step of providing a window over the packet-switched network to a display of the user interface device, said window having a pull-down menu that includes said series of predefined criteria for selecting a subset of the participants.

44. The method of claim 43 wherein said predefined criteria include levels of expertise in predefined categories.

45. The method of claim 43 wherein said predefined criteria are selected from the group consisting of activities, hobbies, demographics, subjects studied, and professional affiliations.

46. The method of claim 34 wherein said user and said plurality of individuals are subscribers to a common service.

47. The method of claim 46 wherein said common service is an Internet service provider.

48. The method of claim 46 wherein said common service is offered by a search engine operator.

49. The method of claim 43 wherein said window further includes a text box for receiving user evaluations of the information site.

50. The method of claim 43 wherein said window further includes a pull-down menu that includes a list of predefined ratings reflecting user evaluations of the information site.

51. The method of claim 43 wherein said plurality of individuals providing an evaluation includes a plurality of participants and said window further includes a text box allowing the user to specify at least one criterion for selecting a subset of the participants.

52. The method of claim 43 further comprising the step of forwarding an advertisement to the user over the packet-switched network.

53. The method of claim 52 wherein said advertisement is provided in said window.

54. The method of claim 52 wherein the step of forwarding an advertisement includes the step of selecting an advertisement based at least in part on user information located in said database.

55. The method of claim 34 further comprising the step of providing connectivity to the packet-switched network for the user interface device.

56. The method of claim 34 wherein said database includes biographic information concerning said individuals.

57. The method of claim 56 wherein said biographic information includes self-rated levels of expertise in predefined categories.

58. The method of claim 56 wherein said biographic information includes categories of information selected from the group consisting of activities, hobbies, demographics, subjects studied, and professional affiliations.

59. An online system for providing an evaluation of a plurality of information sites to a user over a packet-switched network when the user submits a search request through a user interface device in communication with the packet-switched network, said apparatus comprising:
a database that includes at least one evaluation of at least one of the information sites and a network address thereof, said evaluation being provided by at least one individual who was previously in communication with said at least one of the information sites over the packet-switched network;
a processor for developing a rating based on said at least one evaluation; and
a server in communication with the packet-switched network for receiving a search result, responsive to the search request, which includes network addresses for the plurality of information sites and for forwarding said rating to the user over the packet-switched network.

60. The online system of claim 59 wherein the search request is received by the server from an Internet service provider that forwards the search request from the user.

61. The online system of claim 59 wherein said evaluation is a quantitative evaluation.

62. The online system of claim 59 wherein said evaluation is a qualitative evaluation.

63. The online system of claim 59 wherein the rating includes a ranking of the plurality of information sites.

64. The online system of claim 59 wherein said packet-switched network is the Internet and said network address is an Internet address.

65. The online system of claim 64 wherein said Internet address is a URL.

66. The online system of claim 59 wherein said information site is an Internet site.

67. The online system of claim 66 wherein said Internet site is a web site.

68. The online system of claim 59 wherein the user interface device is a personal computer.

69. The online system of claim 68 wherein said personal computer includes an Internet browser through which the search request is submitted.

70. The online system of claim 59 further comprising means for providing a window over the packet-switched network to a display of the user interface device, said window including a user selectable icon allowing the user to request that search results be presented in rank order.

71. The online system of claim 70 wherein said at least one individual providing an evaluation includes a plurality of participants and said window further includes a pull-down menu that includes a list of predefined criteria for selecting a subset of the participants.

72. The online system of claim 71 wherein said predefined criteria include self-rated levels of expertise in predefined categories.

73. The online system of claim 71 wherein said predefined criteria are selected from the group consisting of activities, hobbies, demographics, subjects studied, and professional affiliations.

74. The online system of claim 59 wherein said user and said at least one individual are subscribers to a common service.

75. The online system of claim 74 wherein said common service is an Internet service provider.

76. The online system of claim 74 wherein said common service is offered by a search engine operator.

77. The online system of claim 70 wherein said window further includes a text box for receiving user evaluations of the information site.

78. The online system of claim 70 wherein said window further includes a pull-down menu that includes a list of predefined ratings reflecting user evaluations of the information site.

79. The online system of claim 70 wherein said at least one individual providing an evaluation includes a plurality of participants and said window further includes a text box allowing the user to specify at least one criterion for selecting a subset of the participants.

80. The online system of claim 70 further comprising means for forwarding an advertisement to the user over the packet-switched network.

81. The online system of claim 80 wherein said advertisement is provided in said window.

82. The online system of claim 80 further comprising means for selecting the advertisement based at least in part on the search request.

83. The online system of claim 80 further comprising means for selecting the advertisement based at least in part on user information located in said database.

84. The online system of claim 59 wherein said search request is a key word search request.

85. The online system of claim 59 wherein said server also provides connectivity to the packet-switched network for the user interface device.

86. The online system of claim 59 wherein said database includes biographic information concerning said at least one individual.

87. The online system of claim 86 wherein said biographic information includes self-rated levels of expertise in predefined categories.

88. The online system of claim 86 wherein said biographic information includes categories of information selected from the group consisting of activities, hobbies, demographics, subjects studied, and professional affiliations.

89. A method for providing an evaluation of a plurality of information sites to a user over a packet-switched network when the user submits a search request through a user interface device in communication with the packet-switched network, said method comprising the steps of:
acquiring a search result, responsive to the search request, which includes network addresses for the plurality of information sites;
selecting a plurality of individuals who were previously in communication with at least one of the information sites over the packet-switched network and who meet at least one predefined criterion selected by the user;
retrieving from a database a plurality of evaluations of at least one of the information sites, said evaluations being provided by said plurality of individuals who were previously in communication with said at least one of the information sites over the packet-switched network;
forwarding a rating based on said evaluations to the user over the packet-switched network;
selecting an advertisement based at least in part on information received from the user; and
forwarding said advertisement to the user over the packet-switched network.

90. The method of claim 89 wherein the step of acquiring a search result includes the step of receiving the search result over the packet-switched network.

91. The method of claim 90 wherein the search request is submitted to a search engine and the search result is received from the search engine.

92. The method of claim 89 wherein the step of acquiring a search result includes the step of searching a second database to develop the search result.

93. The method of claim 90 wherein the search request is received from an Internet service provider that forwards the search request from the user.

94. The method of claim 89 wherein said evaluations are quantitative evaluations.

95. The method of claim 89 wherein said evaluations are qualitative evaluations.

96. The method of claim 95 wherein the rating includes a ranking of the plurality of information sites.

97. The method of claim 89 wherein said packet-switched network is the Internet and said network address is an Internet address.

98. The method of claim 97 wherein said Internet address is a URL.

99. The method of claim 89 wherein said information site is an Internet site.

100. The method of claim 99 wherein said Internet site is a web site.

101. The method of claim 89 wherein the user interface device is a personal computer.

102. The method of claim 101 wherein said personal computer includes an Internet browser through which the search request is submitted.

103. The method of claim 89 further comprising the step of providing a window over the packet-switched network to a display of the user interface device, said window including a user selectable icon allowing the user to request that search results be presented in rank order.

104. The method of claim 103 wherein said plurality of individuals providing an evaluation includes a plurality of participants and said window further includes a pull-down menu that includes said series of predefined criteria for selecting a subset of the participants.

105. The method of claim 104 wherein said predefined criteria include self-rated levels of expertise in predefined categories.

106. The method of claim 104 wherein said predefined criteria are selected from the group consisting of activities, hobbies, demographics, subjects studied, and professional affiliations.

107. The method of claim 89 wherein said user and said plurality of individuals are subscribers to a common service.

108. The method of claim 107 wherein said common service is an Internet service provider.

109. The method of claim 107 wherein said common service is offered by a search engine operator.

110. The method of claim 103 wherein said window further includes a text box for receiving user evaluations of the information site.

111. The method of claim 103 wherein said window further includes a pull-down menu that includes a list of predefined ratings reflecting user evaluations of the information site.

112. The method of claim 103 wherein said plurality of individuals providing an evaluation includes a plurality of participants and said window further includes a text box allowing the user to specify at least one criterion for selecting a subset of the participants.

113. The method of claim 89 wherein the step of selecting an advertisement includes the step of selecting an advertisement based at least in part on the selected predefined criteria

114. The method of claim 89 wherein said advertisement is provided in said window.

115. The method of claim 89 wherein the step of selecting an advertisement includes the step of selecting an advertisement based at least in part on the search request.

116. The method of claim 89 wherein the step of forwarding an advertisement includes the step of selecting an advertisement based at least in part on user information located in said database.

117. The method of claim 89 wherein said search request is a key word search request.

118. The method of claim 89 further comprising the step of providing connectivity to the packet-switched network for the user interface device.

119. The method of claim 89 wherein said database includes biographic information concerning said plurality of individuals.

120. The method of claim 119 wherein said biographic information includes self-rated levels of expertise in predefined categories.

121. The method of claim 119 wherein said biographic information includes categories of information selected from the group consisting of activities, hobbies, demographics, subjects studied, and professional affiliations.
